(19) United States
(12) Patent Application Publication
(10) Pub. No.: US 2015/0378539 A1
(43) Pub. Date: Dec. 31, 2015

(54) POP-UP VERIFICATION PANE

(71) Applicant: ABBYY Development LLC, Moscow (RU)

(72) Inventors: Voronko Artem Nickolaevich, Moscow (RU); Kolodkina Natalia Aleksandrovna, Moscow (RU)

(21) Appl. No.: 14/508,531

(22) Filed: Oct. 7, 2014

(30) Foreign Application Priority Data
Jun. 27, 2014 (RU) 2014126236

(51) Int. Cl. G06F 3/0484; G06F 17/24

(52) U.S. Cl. CPC G06F 3/0484; G06F 17/24

(57) ABSTRACT

A text based document comprising textual content is presented to a user. One or more potential errors in the textual content are identified and a visual indication of each of the potential errors is presented to the user. A pop-up pane for a first potential error of the one or more errors is presented, wherein the pop-up pane comprises one or more options for correcting the potential error. An input focus is maintained on the presented textual content to facilitate a user manually entering a correction in the presented textual content. If a user selection of one of the one or more options is received, the potential error is corrected in accordance with the option selected.

### CROSS REFERENCE TO RELATED APPLICATIONS

The present application claims the benefit of priority under 35 USC 119 to Russian Patent Application No. 2014126236, filed Jun. 27, 2014; the disclosure of which is incorporated herein by reference.

### TECHNICAL FIELD

The present disclosure is generally related to computing devices, and is more specifically related to systems and methods for facilitating error correction in electronic documents.

### BACKGROUND

Optical Character Recognition (OCR) is the electronic conversion of scanned or photographed images of typewritten or printed text into computer-readable text. OCR is a common method of digitizing printed texts so that they can be electronically edited, searched, displayed on-line, and used in processes such as text-to-speech, data extraction, and text mining. Some commercial OCR systems are capable of reproducing formatted output that closely approximates the original scanned page including images, columns, and other non-textual components. However, while OCR processing executes with a high degree of accuracy for most fonts, errors in the resulting text (spelling, grammatical, spacing, uncertainly recognized characters, etc.) are common.

### BRIEF DESCRIPTION OF THE DRAWINGS

The present disclosure is illustrated by way of examples, and not by way of limitation, and may be more fully understood with references to the following detailed description when considered in connection with the figures, in which:

FIG. 1 depicts a block diagram of one embodiment of a computing device operating in accordance with one or more aspects of the present disclosure;

FIG. 2 illustrates an example of an application window, in accordance with one or more aspects of the present disclosure;

FIGS. 3A-3B illustrate examples of various representations of a pop-up verification pane operating in accordance with one or more aspects of the present disclosure;

FIGS. 4A-4B illustrate examples of various representations of a pop-up verification pane that provides suggestions operating in accordance with one or more aspects of the present disclosure;

FIG. 5 depicts a flow diagram of an illustrative example of a method of displaying a pop-up verification pane within a text editor, in accordance with one or more aspects of the present disclosure; and

FIG. 6 depicts a more detailed diagram of an illustrative example of a computing device implementing the methods described herein.

### DETAILED DESCRIPTION

Described herein are methods and systems for processing electronic documents by computing devices to facilitate verification and correction of potential optical character recognition (OCR) errors, spelling errors, and any other type of error in the recognized text.

“Electronic document” herein shall refer to a file comprising one or more digital content items that may be visually rendered to provide a visual representation of the electronic document (e.g., on a display or a printed material). In various illustrative examples, electronic documents may conform to certain file formats, such as PDF, DOC, ODT, etc.

“Computing device” herein shall refer to a data processing device having a general purpose processor, a memory, and at least one communication interface. Examples of computing devices that may employ the methods described herein include, without limitation, desktop computers, notebook computers, tablet computers, smart phones, and various other mobile and stationary computing devices.

Commercial OCR systems are capable of reproducing formatted output that closely approximates the original scanned page including images, columns, and other non-textual components. However, while OCR processing executes with a high degree of accuracy for most fonts, errors in the resulting text (spelling, grammatical, spacing, uncertainly recognized characters, etc.) are common. After OCR is completed on an image, the user has the opportunity to review the resulting electronic text document to examine the parts of the text that appear to contain errors in order to make appropriate corrections. Various common implementations of applications devoted to OCR verification use two separate display panes that operate independently from one another—one pane to verify the potential errors (the verifier) and the other to edit the resulting text document (the editor). Typically, if a user is reviewing a text document to verify identified potential errors, the verifier generally overlaps the main text editor and takes control of the user interface without permitting direct access to the underlying text. Traditional verifiers do not display the full context of the original image, displaying only a limited amount of underlying text for correction and providing only limited functionality for working with that underlying text. The user would need to terminate the verifier in order to make anything more than simple in-line editing changes to the text and would then need to take some action to restart the verifier to continue. Similarly, if an error is encountered near the end of a particular document page and carries forward to the next page, a verifier would commonly interpret this as two separate errors and force the user to terminate the verifier to correct the entire error. The repeated starting and stopping of the verifier can lead to a waste of processor resources as well as decrease user operational efficiency.

The present disclosure addresses the above noted and other deficiencies by transferring the functionality of the verifier to the editor, thereby eliminating the verifier as a separate display pane. Aspects of the present disclosure provide the opportunity for simultaneous use of special means for correcting OCR errors, spelling errors, grammatical errors, and the like, concurrently with a text editor that permits direct editing of the document. In some implementations, a user may scroll through the document to examine potential errors while having direct access to the surrounding contextual text. A user may shift between errors, compare potential errors with an associated image, implement mass replacements (replacement of similar errors throughout a document), and select from one or more corrective actions displayed in a pop-up pane.

Various aspects of the above referenced methods and systems are described in details herein below by way of examples, rather than by way of limitation. In an illustrative example, a text based document that contains textual content is presented to the user. The text based document may comprise one or more character strings in one or more encodings (e.g., ASCII, UTF-8, etc.). The text based document may have been produced as a result of the OCR processing of an image. The document may be presented via a stand-alone application, a component of a text editing application, or in any other manner. In some implementations, the document may be presented to the user where one portion of an application window presents the text based document (text portion), and another portion of the application window simultaneously presents the image associated with the text based document (image portion). In one illustrative example, the text based document can be displayed in the top portion of the window and the image can be simultaneously displayed in the bottom portion. Alternatively, the image can be displayed in the top portion and the text based document can be simultaneously displayed in the bottom portion. In another illustrative example, the text based document can be displayed on the left portion of the screen and the image can be simultaneously displayed in the right portion of the screen, and vice versa.

Any potential errors that exist in the text can be identified in the textual content and a visual indication of each of the potential errors can be provided in the presented textual content. The visual indication may include, for example, highlighting or underlining the potential error within the textual content. For example, a spelling error in the text can be underlined in red and a grammatical error can be underlined in green. Additionally, an uncertainly recognized character in the text document that was generated by OCR processing of an image may be highlighted in a particular color (e.g., yellow). An uncertainly recognized character may be present in the text if the applicable portion of the associated image was not clearly recognized with certainty by OCR processing. These characters may not be recognized if they do not belong to words in a language specific dictionary. For example, uncertainly recognized characters may be proper names, foreign words or expressions, or are simply from another language.

Subsequently, a pop-up pane may be presented to the user for the first potential error identified in the text document with or without requiring any user input to initiate the pop-up pane. For example, if the user launches a stand-alone verification application, the application display window is presented to the user and the pop-up pane is immediately presented for the first potential error identified in the document. Alternatively, the pop-up pane can be presented upon user request, for example by clicking a button in the application window or pressing a particular sequence of keys on a keyboard. The pop-up pane may be a small window displayed on top of the text in a larger window and may include a list of options such as one or more options for correcting the potential error.

In certain implementations, the pop-up pane may comprise at least one of an ignore option, an add option, or a replace option. The ignore option can be used to ignore the potential error without making any corrections in the text. The add option can be used in the event that the text associated with the potential error represents a word or character that is not in the dictionary of words used by the application. For example, if a user selects the add option, the uncertainly recognized word or character associated with the potential error will be added to the dictionary for use with further recognition, and the word or character will no longer be marked as a potential error. The replace option can be used to replace the text associated with the potential error with a known word from a dictionary of words used by the application. The replace option may comprise a list of recognized words from the dictionary of words associated with the potential error (e.g., words from the dictionary that have similar but not identical spelling as the text including a potential error). A dictionary used by the application may be one or more general and/or specialized dictionaries that include a collection of commonly-used words in a certain language. Input focus remains on the presented textual content to facilitate a user manually entering a correction in the textual content. For example, if the user wishes to replace the potential error with a word that is not among the suggestions provided by the replace option, the user may simply type the correction into the text without terminating the pop-up pane.

Once the pop-up pane is presented, the input cursor may be positioned so that it is pointing to the first character of the text segment in a text portion pertaining to the first potential error (e.g., a word that is potentially misspelled). Additionally, a visual indication may be provided for the text segment pertaining to the first potential error. For example, the text segment of the potential error may be highlighted in its entirety. Alternatively, the text segment of the potential error may be entirely surrounded with a colored text box. In an illustrative example, the pop-up pane may be presented beneath and at the center of the text segment comprising the first potential error without obscuring the potential error from the user's view. In some implementations, the text segment comprising the first potential error may be presented uniformly within a predefined zone of a display when the pop-up pane is presented to the user. For example, when the pop-up pane is presented for an identified potential error, the text segment of the error may be displayed on the first line of text within the application window. Alternatively, the text segment of the error may be displayed in the center of the application window or in any other location within the application window. In an illustrative example, when the pop-up pane is presented for the next potential error, the text segment for that next potential error is then displayed in the predefined zone so the pop-up pane will be presented in the same location within the display window for each potential error in the document.

In one illustrative example, presenting the pop-up pane beneath a potential error may also provide a visual indication of that error in an associated image. For example, if an application window displays both the text document and the associated image (as noted in the example above), the presentation of the pop-up pane in the text document in the text portion of the application window can also result in a visual indication of that error in the appropriate location of the image in the image portion of the application window. The visual indication of the error in the image may be performed by highlighting of the area of the image in a particular color, displaying a box around the text, modifying the font or size of the text, or in any other manner.

In response to user selection of one of the options listed in the pop-up pane, the potential error is corrected in accordance with the selected option. For example, if the user selects an ignore option, no correction is made to the text and any visual indication applied to the text associated with the error is removed. Alternatively, if the user selects an add option, the text associated with the potential error can be added to a dictionary of words used by the application. If the user selects one of the words listed by the replace option, the text is replaced with the word selected from the list. In certain implementations, the pop-up pane options can be modified by the user by invoking a predefined command on an input device. For example, if the user presses a particular key on the keyboard (e.g. the CTRL key), the ignore and replace commands change to “ignore all” and “replace all” respectively. Thus, if the user selects one of those two options, the corrective action can be applied not only to the specific potential error associated with the pop-up pane, but also to all occurrences of the same potential error identified throughout the entire text document.

Once the selected corrective action is taken, the pop-up pane may then be presented for the next potential error identified in the text document. The user may then select one of the options for the next potential error and the process can repeat until all of the potential errors in the text document have been addressed, so long as the user does not interrupt the process.

In some implementations, the pop-up panel may be closed by selecting text from another area of the document. For example, if the user clicks with a mouse on another word in the document or any other area of the application window that is not the pop-up pane itself. Once the pop-up pane has been closed, it can be restarted upon user request as noted above. Additionally, the user may restart the pop-up pane by selecting one of the identified potential errors in the document. In one illustrative example, the user may click on any potential error in the document with a particular mouse button (the left button, for example) to restart the pop-up pane. Once restarted, the pop-up pane is presented in association with the potential error selected by the user as described above.

Aspects of the present disclosure are thus capable of combining the verifier and editor into a single application window, thereby increasing the efficiency of the process and limiting any waste of system resources. Additionally, the pop-up pane functionality may be utilized by the user entirely via a keyboard, which provides ergonomic benefits with regard to operational efficiency in that the user's hands never need to leave the keys to touch a mouse or other input device. Moreover, uniformity in the spatial presentation of the pop-up pane across multiple errors within a single document facilitates habitual user interaction, thereby improving operator attention to detail and increasing the speed with which errors are recognized and processed.

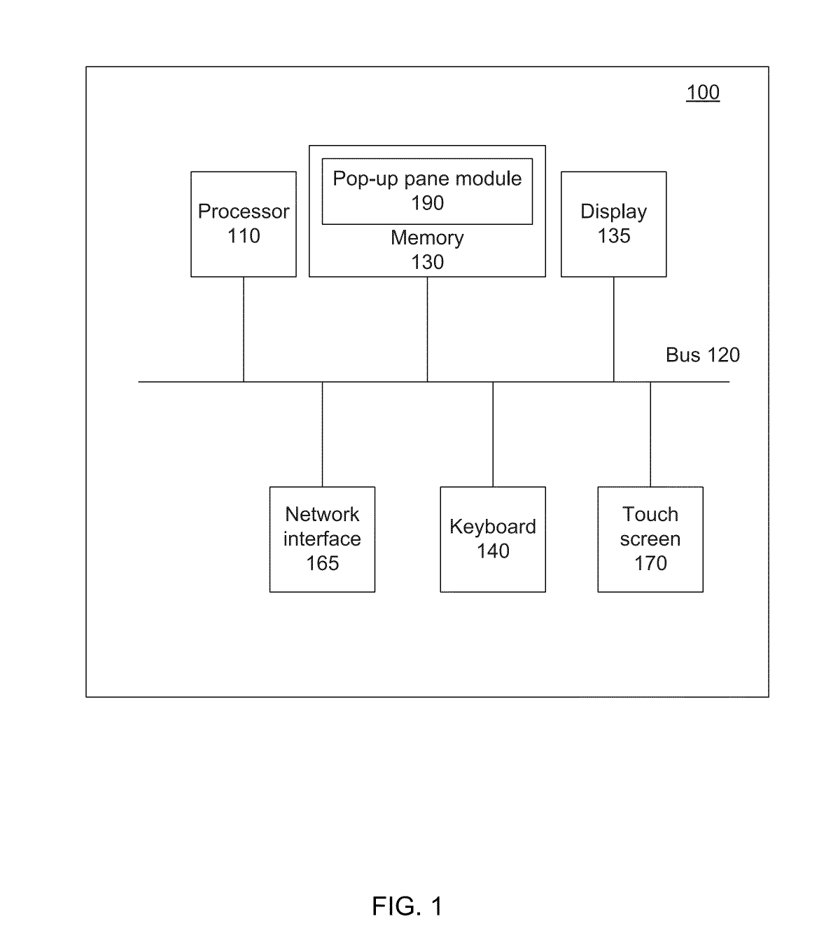

FIG. 1 depicts a block diagram of one illustrative example of a computing device 100 operating in accordance with one or more aspects of the present disclosure. In illustrative examples, computing device 100 may be provided by various computing devices including a tablet computer, a smart phone, a notebook computer, or a desktop computer.

Computing device 100 may comprise a processor 110 coupled to a system bus 120. Other devices coupled to system bus 120 may include memory 130, display 135 equipped with a touch screen input device 170, keyboard 140, and one or more communication interfaces 165. The term “coupled” herein shall include both electrically connected and communicatively coupled via one or more interface devices, adapters and the like.

Processor 110 may be provided by one or more processing devices including general purpose and/or specialized processors. Memory 130 may comprise one or more volatile memory devices (for example, RAM chips), one or more non-volatile memory devices (for example, ROM or EEPROM chips), and/or one or more storage memory devices (for example, optical or magnetic disks).

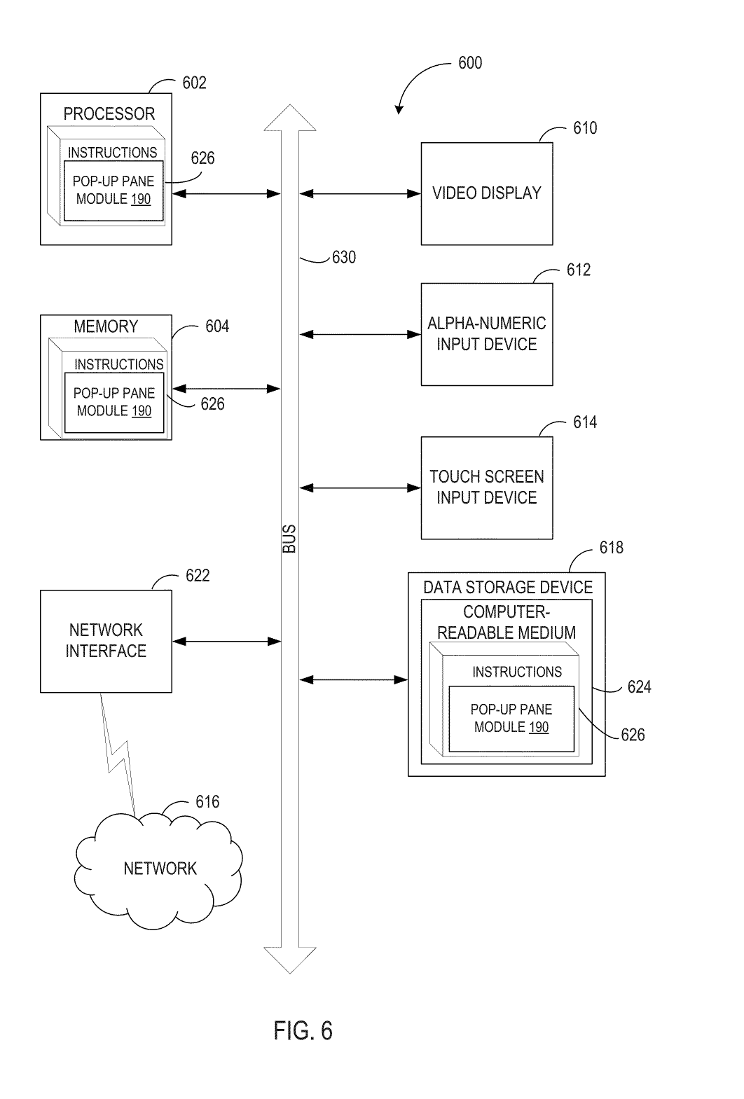

In certain implementations, computing device 100 may comprise a touch screen input device 170 represented by a touch-sensitive input area and/or presence-sensitive surface overlaid over display 135. An example of a computing device implementing aspects of the present disclosure will be discussed in more detail below with reference to FIG. 6.

In certain implementations, memory 130 may store instructions of a pop-up pane module 190 for facilitating text verification and error correction in electronic documents using a pop-up verification pane within a text editor, as described above and in further detail below. In an illustrative example, pop-up pane module 190 may be implemented as a function to be invoked via a user interface of another application (e.g., an electronic document editing application). Alternatively, pop-up pane module 190 may be implemented as a stand-alone application.

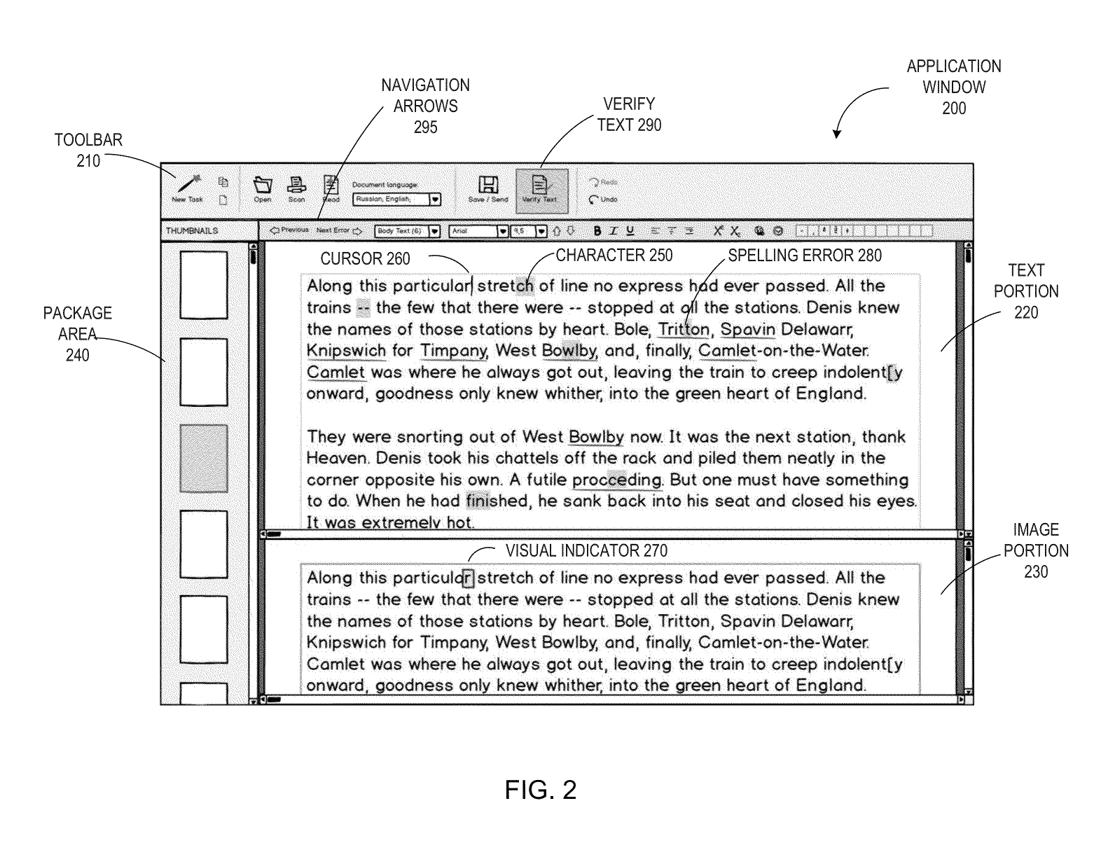

FIG. 2 illustrates an example of an application window 200 within which a pop-up pane may be presented. Application window 200 may be presented by a stand-alone application, a component of a text editing application, or in any other manner. Application window 200 may include text editing functions presented to the user in toolbar 210. Toolbar 210 can include such basic editor functionality as open, scan, read, save, redo, and undo. Additionally, toolbar 210 can include text formatting functions such as font selection, font size, bold type, underline, and the like.

In some implementations, application window 200 includes text portion 220 that presents the text based document and image portion 230 that presents the image associated with the text based document. Text portion 220 may be presented in the top portion of application window 200 and image portion 230 in the bottom portion of application window 200. Alternatively, image portion 230 may be presented in the top portion of application window 200 and text portion 220 in the bottom portion. In another illustrative example, text portion 220 and image portion 230 may be displayed in the left and right portions of application window 220 respectively. Additionally, application window 200 can present package area 240 that contains a list of the pages in the document for simplified document navigation. Package area 240 may appear as a set of page thumbnails, as a detailed list of information about each page, or in any other manner. Application window 200 may also include an additional zoom window (not pictured) that shows an enlarged portion of the image associated with the text based document.

In certain implementations, image portion 230 displays the position of the image that corresponds with the position of the text document displayed in text portion 220. For example, as shown in FIG. 2, the image displayed in image portion 230 corresponds to the text displayed in text portion 220. In some implementations, when the user scrolls through the text based document in text portion 220, the image displayed in image portion 230 can scroll equivalently. If a user moves a cursor 260 to a particular position in the text, visual indicator 270 can highlight the corresponding location in the image. Similarly, although not pictured in FIG. 2, when the pop-up pane is presented in text portion 220 for a potential error, visual indicator 270 can highlight the position in the image that corresponds to the potential error.

When launched, the application may scan through the entire text document to identify all potential errors in the textual content of the document. In one embodiment, the user may select verify text button 290 to initiate scanning of the text document. Potential errors can include spelling errors, grammatical errors, spacing errors, uncertainly recognized characters, and the like. Any potential errors that exist in the text are identified in the textual content and a visual indication of each of the potential errors is provided in the presented textual content. The visual indication may include, for example, highlighting or underlining the potential error within the textual content. For example, a spelling error in the text can be underlined in red as shown by spelling error 280. Additionally, an uncertainly recognized character in the text document that was generated by OCR processing of an image may be highlighted in a particular color (e.g. yellow) as shown by character 250. An uncertainly recognized character may be present in the text if, for example, the applicable portion of the associated image was not recognized accurately by OCR processing.

Once potential errors have been identified and visually indicated by application window 200, a pop-up pane can be presented for the first potential error in response to user input. For example, the pop-up pane can be displayed in response to the user clicking the verify text 290 button of toolbar 210. Alternatively, the pop-up pane can be presented for the first potential error without any interaction required on the part of the user upon application start-up (not shown in FIG. 2). The user may select one of the options presented by the pop-up pane to correct or ignore the potential error, or the user may proceed to the next potential error without taking any action on the currently identified error. The presentation of the text including a potential error along with the surrounding textual context makes it easier for the user to select an appropriate option. The user may proceed to the next potential error by clicking navigation arrows 295 in the toolbar 210 of application window 200. Alternatively, the user may use the keyboard to proceed to the next potential error. For example, the user may hold down the ALT key on the keyboard and press the left or right arrow keys to navigate between potential errors without taking any corrective action on those errors. In some implementations, the user can use a mouse to move the cursor over the potential error of interest and click on the error, which can move the pop-up pane to that particular error. In some implementations, once the user has selected one of the options presented by the pop-up pane to correct or ignore the potential error, the pop-up pane is automatically (without any user interaction) presented for the next potential error in the text. In some implementations, since the pop-up pane is presented within the text editor and does not intercept keyboard input focus, the user may directly update the text. For example, if the pop-up pane does not suggest an acceptable corrective action, the user may simply type in the text without having to terminate the pop-up pane. Similarly, the user may utilize any of the tools available in toolbar 210 without needing to take an affirmative action to terminate the pop-up pane. For example, the user may change the font, the typeface (bold, underline, etc.), or any other aspect of the text for which the editor provides functionality.

In certain implementations, the user may terminate the pop-up pane by invoking a particular command on an input device. For example, the user may hit the ESC key on a keyboard. To restart the pop-up pane, the user may click on the navigation arrows 295 of toolbar 210, use the keyboard as outlined above, or may utilize a particular command dedicated to presenting the pop-up pane such as shown by verify text 290 button of toolbar 210.

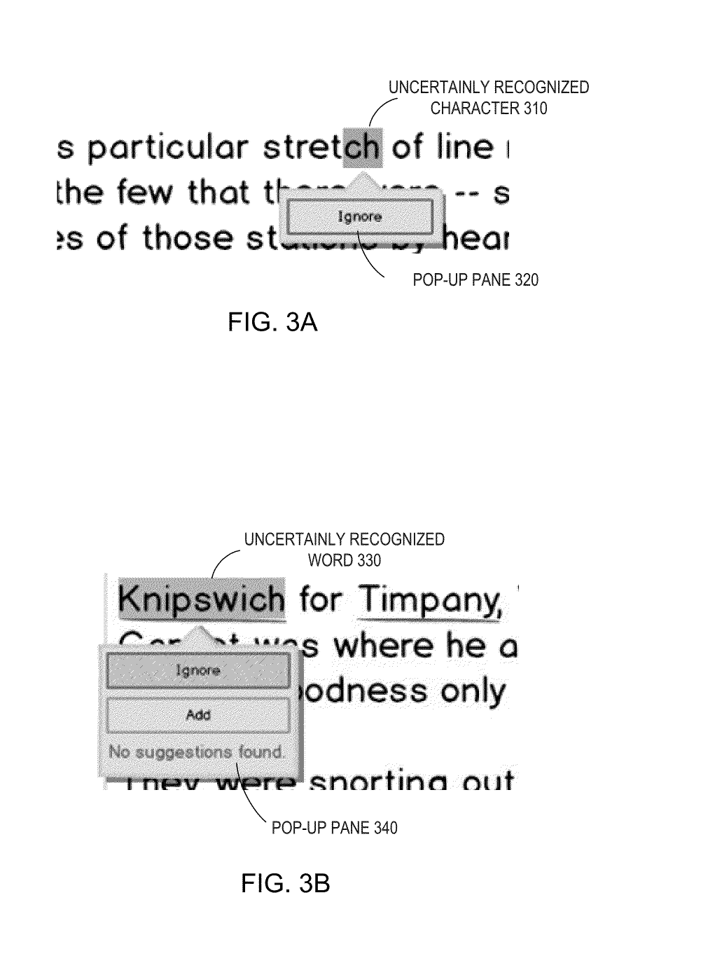

FIGS. 3A and 3B illustrate examples of various representations of a pop-up verification pane. FIG. 3A illustrates an example of a pop-up pane 320 that may be presented when an uncertainly recognized character 310 is encountered in the text document. A character may be uncertainly recognized if the applicable portion of the associated image was not clearly recognized with certainty by OCR processing. The uncertainly recognized character 310 may be highlighted with a visual indication during the error identification process described above. The pop-up pane can be presented immediately beneath and at the center of uncertainly recognized character 310, comprising any corrective actions available. In one illustrative example, the ignore option is presented by default in pop-up pane 320. The user may select the ignore option by using the keyboard or a mouse. If the user selects the ignore option, the visual indication can be removed for uncertainly recognized character 310 and the pop-up pane may proceed to the next potential error in the text document.

FIG. 3B illustrates an example of a pop-up pane 340 that may be presented when an uncertainly recognized word 330 is encountered in the text document. A word may be uncertainly recognized if the word is not in a dictionary of words associated with the application. If the pop-up pane cannot identify any suggestions for replacement of the uncertainly recognized word, the pop-up pane may present “no suggestions found” or a similar message to the user as shown in pop-up pane 340. Additionally, pop-up pane 340 may present an option for the user to add the uncertainly recognized word 330 to the dictionary of words used by the application so that future occurrences of the word will not be identified as potential errors.

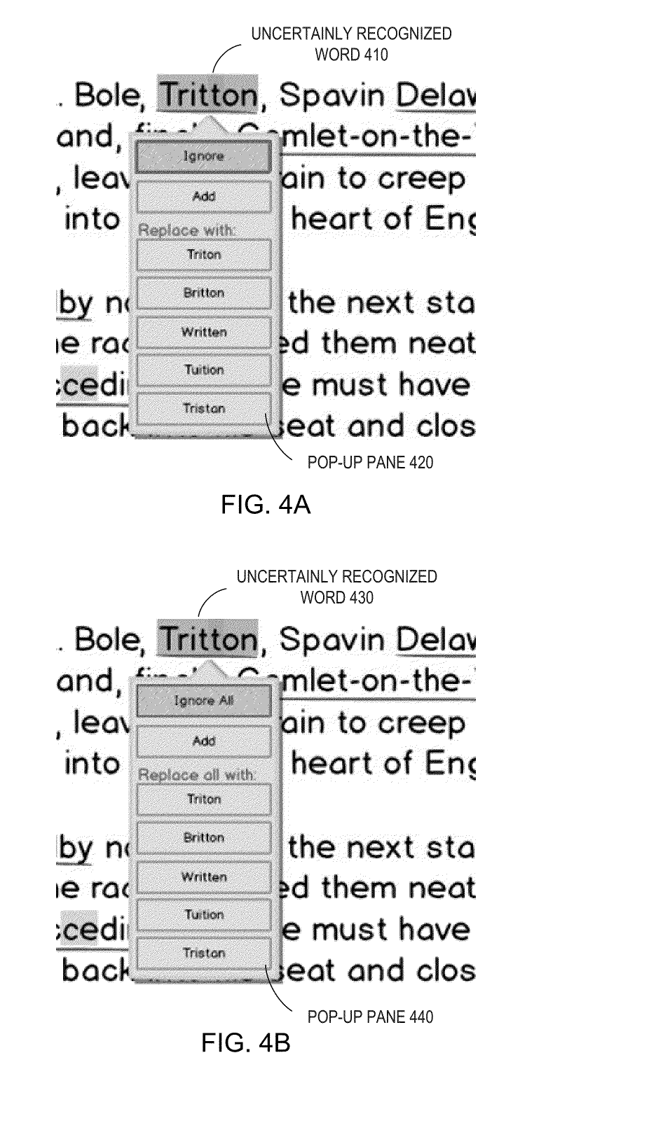

FIGS. 4A and 4B illustrate examples of various representations of a pop-up verification pane that provides suggestions for corrective action. FIG. 4A illustrates an example of a pop-up pane 420 that may be presented when an uncertainly recognized word 410 is encountered in the text document, but for which the pop-up pane 420 can identify suggestions for replacement from within a dictionary of words. Pop-up pane 420 may present the ignore and add options in addition to a list of suggested words that the user may choose for replacement. In an illustrative example, pop-up pane 420 can be presented with a width only as large as the longest suggested word, and a height limited to no more than six lines. If the list of suggested words is longer than six words, pop-up pane 420 can be presented with a scroll bar to scroll through the entire list of suggestions.

In certain implementations, the pop-up pane options can be modified by the user by invoking a predefined command on an input device, which is illustrated in FIG. 4B. Similar to FIG. 4A, a pop-up pane 440 may be presented when an uncertainly recognized word 430 is encountered in the text document. If the user presses a particular key on the keyboard (e.g. the CTRL key), the ignore and replace commands can change in pop-up pane 440 to “ignore all” and “replace all” respectively. Thus, if the user selects one of those two options, the corrective action can be applied not only to the specific potential error associated with the pop-up pane, but also to all occurrences of the same potential error identified throughout the entire text document.

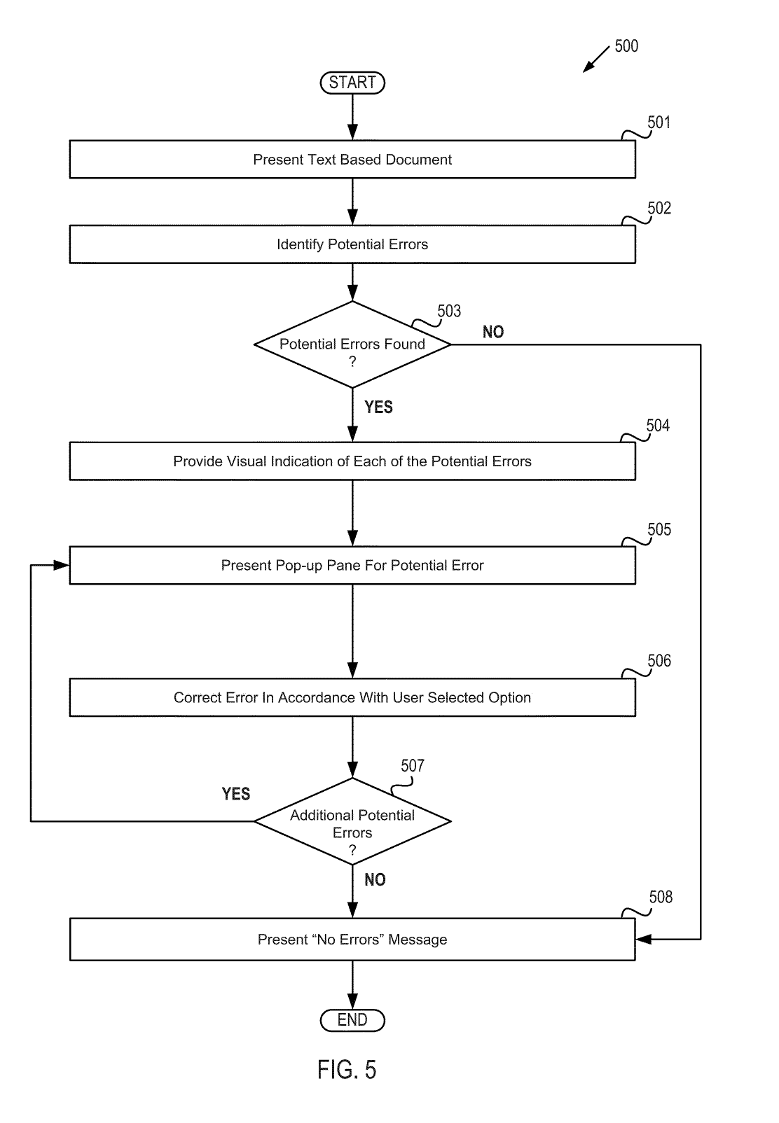

FIG. 5 depicts a flow diagram of one illustrative example of a method 500 for displaying a pop-up verification pane within a text editor, in accordance with one or more aspects of the present disclosure. The method may be performed by processing logic that may comprise hardware (circuitry, dedicated logic, etc.), software (such as is run on a general purpose computer system or a dedicated machine), or a combination of both. In one illustrative example, method 500 may be performed by pop-up pane module 190 of computing device 100 of FIG. 1. Alternatively, some or all of method 500 might be performed by another machine. In certain implementations, method 500 may be performed by a single processing thread. Alternatively, method 500 may be performed by two or more processing threads, each thread executing one or more individual functions, routines, subroutines, or operations of the method. It should be noted that blocks depicted in FIG. 5 could be performed simultaneously or in a different order than that depicted.

At block 501, processing logic presents a text based document to the user. In an illustrative example, text based document may comprise one or more character strings in one or more encodings (e.g., ASCII, UTF-8, etc.). The text based document may have been produced as a result of the OCR processing of an image. The document may be presented via a stand-alone application, a component of a text editing application, or in any other manner. In some implementations, the document may be presented to the user where one portion of an application window presents the text based document (the text portion) and another portion of the application window presents the image associated with the text based document (the image portion), such as in application window 200 of FIG. 2.

At block 502, processing logic identifies potential errors in the text based document. Processing logic may scan the entire document to identify spelling errors, grammatical errors, spacing errors, uncertainly recognized characters, and the like. In one illustrative example, processing logic may scan the document starting from the beginning of the first page. Alternatively, processing logic may start the scan from the current page being viewed by a user. If the scan is started from the current page in response to user input, processing logic can scan from the current page forward in the document and, if no errors are found, continue scanning from the first page. At block 503, processing logic determines whether potential errors have been found in the document. If processing logic determines that there are potential errors to be processed, execution proceeds to block 504. Otherwise, processing logic bypasses blocks 504 through 507 and proceeds to block 508.

At block 504, processing logic provides a visual indication of each of the potential errors found in the document at block 502. The visual indication may include, for example, highlighting or underlining the potential error within the textual content. For example, a spelling error in the text can be underlined in red and a grammatical error can be underlined in green. Additionally, an uncertainly recognized character in the text document that was generated by OCR processing of an image may be highlighted in a particular color (e.g. yellow). An uncertainly recognized character may be present in the text if the applicable portion of the associated image was not recognized accurately by OCR processing.

At block 505, processing logic presents a pop-up pane for the first potential error identified. The pop-up pane may comprise one or more options for correcting the potential error. In certain implementations, the pop-up pane may comprise at least one of an ignore option, an add option, or a replace option. The ignore option can be used to ignore the potential error without making any corrections in the text. The add option can be used in the event that the text associated with the potential error represents a word or character that is not in the dictionary of words used by the application. For example, if a user selects the add option, the uncertainly recognized word or character associated with the potential error will be added to the dictionary for use with further recognition, and the word or character will no longer be marked as a potential error. The replace option can be used to replace the text associated with the potential error with a known word from a dictionary of words used by the application. The replace option may comprise a list of recognized words from the dictionary of words associated with the potential error. Processing logic maintains input focus on the presented textual content to facilitate a user manually entering a correction in the textual content. For example, if the user wishes to replace the potential error with a word that is not among the suggestions provided by the replace option, the user may simply type the correction into the text without terminating the pop-up pane.

At block 506, processing logic corrects the error in accordance with the option selected by the user. If the user selects an ignore option, no correction is made to the text and any visual indication applied to the text associated with the error is removed. Alternatively, if the user selects an add option, the text associated with the potential error can be added to a dictionary of words used by the application. If the user selects one of the words listed by the replace option, the text is replaced with the word selected from the list. In certain implementations, the pop-up pane options can be modified by the user by invoking a predefined command on an input device. For example, if the user presses a particular key on the keyboard (e.g. the CTRL key), the ignore and replace commands can change to ignore all and replace all. Thus, if the user selects one of those two options, the corrective action can be applied not only to the specific potential error associated with the pop-up pane, but also to all occurrences of the same potential error identified throughout the entire text document.

At block 507, processing logic determines whether additional potential errors have been found in the document. If processing logic determines that there are additional potential errors to be processed, execution returns to block 505. So long as there are additional potential errors identified in the document or until a user action to interrupt error correction is received, processing logic will repeat blocks 505-507. Otherwise, execution proceeds to block 508.

At block 508, processing logic presents a message to the user stating that no additional errors have been identified in the document. In one illustrative example, processing logic displays a dialog box requiring the user to confirm that the message has been read. For example, the dialog box may contain a button that should be “pressed” by the user via a mouse or a keyboard. Alternatively, the message may be displayed in a window such that any key stroke or user interface action causes the message window to close. After block 508, the method of FIG. 5 terminates.

FIG. 6 illustrates a more detailed diagram of an example computing device 600 within which a set of instructions, for causing the computing device to perform any one or more of the methods discussed herein, may be executed. The computing device 600 may include the same components as computing device 100 of FIG. 1, as well as some additional or different components, some of which may be optional and not necessary to provide aspects of the present disclosure. The computing device may be connected to other computing device in a LAN, an intranet, an extranet, or the Internet. The computing device may operate in the capacity of a server or a client computing device in client-server network environment, or as a peer computing device in a peer-to-peer (or distributed) network environment. The computing device may be a provided by a personal computer (PC), a tablet PC, a set-top box (STB), a Personal Digital Assistant (PDA), a cellular telephone, or any computing device capable of executing a set of instructions (sequential or otherwise) that specify operations to be performed by that computing device. Further, while only a single computing device is illustrated, the term “computing device” shall also be taken to include any collection of computing devices that individually or jointly execute a set (or multiple sets) of instructions to perform any one or more of the methodologies discussed herein.

Exemplary computing device 600 includes a processor 602, a main memory 604 (e.g., read-only memory (ROM) or dynamic random access memory (DRAM)), and a data storage device 618, which communicate with each other via a bus 630.

Processor 602 may be represented by one or more general-purpose processing devices such as a microprocessor, central processing unit, or the like. More particularly, processor 602 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. Processor 602 may also be one or more special-purpose processing devices such as an application specific integrated circuit (ASIC), a field programmable gate array (FPGA), a digital signal processor (DSP), network processor, or the like. Processor 602 is configured to execute instructions 626 for performing the operations and functions discussed herein.

Computing device 600 may further include a network interface device 622, a video display unit 610, a character input device 612 (e.g., a keyboard), and a touch screen input device 614.

Data storage device 618 may include a computer-readable storage medium 624 on which is stored one or more sets of instructions 626 embodying any one or more of the methodologies or functions described herein. Instructions 626 may also reside, completely or at least partially, within main memory 604 and/or within processor 602 during execution thereof by computing device 600, main memory 604 and processor 602 also constituting computer-readable storage media. Instructions 626 may further be transmitted or received over network 616 via network interface device 622.

In certain implementations, instructions 626 may include instructions for a method of displaying a pop-up verification pane within a text editor, which may correspond to method 600, and may be performed by pop-up pane module 190 of FIG. 1. While computer-readable storage medium 624 is shown in the illustrative examples to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and software components, or only in software.

In the foregoing description, numerous details are set forth. It will be apparent, however, to one of ordinary skill in the art having the benefit of this disclosure, that the present disclosure may be practiced without these specific details. In some instances, well-known structures and devices are shown in block diagram form, rather than in detail, in order to avoid obscuring the present disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “determining”, “computing”, “calculating”, “obtaining”, “identifying,” “modifying” or the like, refer to the actions and processes of a computing device, or similar electronic computing device, that manipulates and transforms data represented as physical (e.g., electronic) quantities within the computing device's registers and memories into other data similarly represented as physical quantities within the computing device memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

It is to be understood that the above description is intended to be illustrative, and not restrictive. Various other implementations will be apparent to those of skill in the art upon reading and understanding the above description. The scope of the disclosure should, therefore, be determined with reference to the appended claims, along with the full scope of equivalents to which such claims are entitled.

What is claimed is:

1. A method comprising:
presenting a text based document, comprising textual content;
identifying one or more potential errors in the textual content;
providing a visual indication of each of the one or more potential errors in the presented textual content;
presenting a pop-up pane for a first potential error of the one or more potential errors, wherein the pop-up pane comprises one or more options for correcting the first potential error;
maintaining an input focus on the presented textual content to facilitate a user manually entering a correction in the presented textual content; and
if a user selection of one of the one or more options in the pop-up pane is received, correcting the potential error in accordance with the selected option.

2. The method of claim 1 further comprising:
presenting the pop-up pane for a next potential error of the one or more potential errors, wherein the pop-up pane comprises one or more options for correcting the next potential error; and
in response to the user selection of one of the one or more options, correcting the next potential error in accordance with the selected option.

3. The method of claim 2 wherein the presenting and correcting are continuously repeated until all potential errors in the textual content have been corrected or until a user action to interrupt error correction in the textual content is received.

4. The method of claim 1 wherein the text based document is generated as a result of optical character recognition processing.

5. The method of claim 1, wherein a visual indication of each of the one or more errors in the presented textual content comprises at least one of highlighting or underlining the one or more potential errors.

6. The method of claim 1, wherein presenting a pop-up pane in association the first potential error of the one or more potential errors comprises:
presenting a text segment comprising the first error within a predefined zone of a display wherein the pop-up pane is located beneath the text segment and at a center of the text portion pertaining to the first error and wherein an input cursor is pointing to a first character of the text segment pertaining to the first potential error; and
providing a second visual indication of the text segment comprising the first error wherein the first error is contained entirely within the second visual indication.

7. The method of claim 1, wherein presenting a text based document comprising textual content comprises presenting the textual content in a text portion of a display and an image associated with the text based document in an image portion of the display.

8. The method of claim 1, wherein the one or more options for correcting the first error comprise at least one of an ignore option, an add option, a replace option, or a text input by the user.

9. The method of claim 8, wherein the replace option comprises a list of recognized words from a dictionary of words, the list of recognized words being associated with the first error.

10. The method of claim 1, wherein the one or more options for correcting the first error are modified upon determining that the user has invoked a predefined command on an input device.

11. A computing apparatus comprising:
a memory to store instructions; and
a processing device, coupled to the memory, to:
present a text based document, comprising textual content;
identify one or more potential errors in the textual content;
provide a visual indication of each of the one or more potential errors in the presented textual content;
present a pop-up pane for a first potential error of the one or more potential errors, wherein the pop-up pane comprises one or more options for correcting the first potential error;
maintain an input focus on the presented textual content to facilitate a user manually entering a correction in the presented textual content; and
if a user selection of one of the one or more options in the pop-up pane is received, correct the potential error in accordance with the selected option.

12. The apparatus of claim 11, wherein a visual indication of each of the one or more errors in the presented textual content comprises at least one of highlighting or underlining the one or more potential errors.

13. The apparatus of claim 11, the processing device to continuously present and correct until all potential errors in the textual content have been corrected or until a user action to interrupt error correction in the textual content is received.

14. The apparatus of claim 11 wherein the text based document is generated as a result of optical character recognition processing.

15. The apparatus of claim 11, wherein to present a pop-up pane in association the first potential error of the one or more potential errors, the processing device is to:
present a text segment comprising the first error within a predefined zone of a display wherein the pop-up pane is located beneath the text segment and at a center of the text segment pertaining to the first error and wherein an input cursor is pointing to a first character of the text segment pertaining to the first potential error; and
provide a second visual indication of the text segment comprising the first error wherein the first error is contained entirely within the second visual indication.

16. The apparatus of claim 11, wherein to present a text based document comprising textual content, the processing device is to present the textual content in a text portion of a display and an image associated with the text based document in an image portion of the display.

17. The apparatus of claim 11, wherein the one or more options for correcting the first error comprise at least one of an ignore option, an add option, a replace option, or a text input by the user.

18. The apparatus of claim 11, wherein the replace option comprises a list of recognized words from a dictionary of words associated with the first error.

19. A non-transitory computer readable storage medium, comprising instructions that, when executed by a processing device, cause the processing device to perform operations comprising:
presenting a text based document, comprising textual content;
identifying one or more potential errors in the textual content;
providing a visual indication of each of the one or more potential errors in the presented textual content;
presenting a pop-up pane for a first potential error of the one or more potential errors, wherein the pop-up pane comprises one or more options for correcting the first potential error;
maintaining an input focus on the presented textual content to facilitate a user manually entering a correction in the presented textual content; and
if a user selection of one of the one or more options in the pop-up pane is received, correcting the potential error in accordance with the selected option.

20. The non-transitory computer readable storage medium of claim 19, wherein the operations further comprise:
presenting the pop-up pane for a next potential error of the one or more potential errors, wherein the pop-up pane comprises one or more options for correcting the next potential error; and
in response to the user selection of one of the one or more options, correcting the next potential error in accordance with the selected option.

21. The non-transitory computer readable storage medium of claim 20 wherein the presenting and correcting are continuously repeated until all potential errors in the textual content have been corrected or until a user action to interrupt error correction in the textual content is received.

22. The non-transitory computer readable storage medium of claim 19 wherein the text based document is generated as a result of optical character recognition processing.

23. The non-transitory computer readable storage medium of claim 19, wherein a visual indication of each of the one or more errors in the presented textual content comprises at least one of highlighting or underlining the one or more potential errors.

24. The non-transitory computer readable storage medium of claim 19, wherein presenting a pop-up pane in association the first potential error of the one or more potential errors comprises:
presenting a text segment comprising the first error within a predefined zone of a display wherein the pop-up pane is located beneath the text segment and at a center of the text segment pertaining to the first error and wherein an input cursor is pointing to a first character of the text segment pertaining to the first potential error; and
providing a second visual indication of the text segment comprising the first error wherein the first error is contained entirely within the second visual indication.

25. The non-transitory computer readable storage medium of claim 19, wherein presenting a text based document comprising textual content comprises presenting the textual content in a text portion of a display and an image associated with the text based document in an image portion of the display.

26. The non-transitory computer readable storage medium of claim 19, wherein the one or more options for correcting the first error comprise at least one of an ignore option, an add option, a replace option, or a text input by the user.
